(19) United States
(12) Patent Application Publication
(10) Pub. No.: US 2011/0001791 A1
(43) Pub. Date: Jan. 6, 2011

(54) METHOD AND SYSTEM FOR GENERATING AND DISPLAYING A THREE-DIMENSIONAL MODEL OF PHYSICAL OBJECTS

(75) Inventors: Gilad Kirshenboim, Petach Tikva (IL); Nitzan GOLDBERG, Jerusalem (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: EMAZE IMAGING TECHONOLGIES LTD., Petach Tikva (IL)

(21) Appl. No.: 12/496,821

(22) Filed: Jul. 2, 2009

(51) Int. Cl. H04N 13/02; G06T 17/10

(52) U.S. Cl. 348/43; 345/420; 348/47; 348/E13.021

(57) ABSTRACT

A system and method for generating three-dimensional models of physical objects, includes the steps of providing a plurality of two dimensional images of a physical object, wherein the two-dimensional images are captured from a plurality of viewing angles of the physical object; associating each of the two-dimensional images with a viewing zone, wherein: the viewing zone includes a range of viewing angles of the physical object; and at least one of the viewing zones having a minimum of three shared boundaries; and processing the associated two-dimensional images for each of the viewing zones to generate a three-dimensional local model of the physical object for each of the viewing zones. In another implementation, views are rendered from a visualized model.

A method and system for generating and displaying a three-dimensional model of physical objects

### FIELD OF THE INVENTION

The present embodiment generally relates to the field of image processing, and in particular, it concerns generating a three-dimensional model from a plurality of two-dimensional images and displaying a view of a three-dimensional model.

### BACKGROUND OF THE INVENTION

There is a desire in many areas to represent a physical object as a three-dimensional model. Applications include realistic modeling of complex objects or interactive navigation in real environments. In e-commerce, a seller can use a three-dimensional model to represent an object for sale, allowing a potential buyer to view the object from any view that the potential buyer wants. This removes the limitations inherent in viewing a limited number of still images and improves the buyer's experience.

The information necessary to produce a three-dimensional model can be supplied by the content owner. For example, the content owner may take digital still pictures, or digital video pictures of a physical object. These digital pictures need to be processed to generate a three-dimensional model. This process may be automated, or involve some degree of manual processing. It is generally desirable to have a high quality three-dimensional model, that is, a model that accurately represents the original physical object, and contains sufficient detail to satisfy the viewer.

Conventional techniques for visualizing physical objects generally use a two-part algorithm to generate a three-dimensional model and display a view of the model. In the first part of the technique, two-dimensional images are used to generate a three-dimensional model of a physical object. This single three-dimensional model is referred to in this document as a global model. A variety of techniques is known in the art for performing this generating, and a variety of definitions exists to evaluate the quality of the generated model. In the second part of the technique, the three-dimensional model is rendered to present a user with a two-dimensional view of the object. It is possible to give the user full control over the viewing of the model, for example, rotating the model, zooming in, and zooming out.

In the conventional technique of using a two-part algorithm, the focus of the first part of the algorithm is to optimize the accuracy of the model generation of a global model. Conventional research is focused on improving the accuracy of the generating of the global model. It is generally believed in the art that generating a more accurate global model will allow the second part of the algorithm to generate a more accurate view of the object for the user.

The paper A comparison and evaluation of multi-view stereo reconstruction algorithms, CVPR 2006, by Seitz E T. AL., presents a description of conventional techniques for generating a three-dimensional model from two-dimensional images. This paper also presents an evaluation methodology that measures the accuracy and completeness of the techniques. The evaluation of a conventional technique is done by calculating a metric of the difference between a ground-truth model (also known as a reference model) and the model generated by the conventional technique. A ground-truth model can be generated by a laser scanner or other devices or techniques that produce a three-dimensional model; this model is then used as the true/real/reference model for an object of interest.

There is a need for an improved method for generating and displaying a three-dimensional model of physical objects. It is desirable that this method use a limited number of two-dimensional images provided by a content owner using commonly available equipment. An example is using a digital camera to capture images, and a home computer to transfer those images for processing into a visualized model. It is also desirable for a viewer to be able to manipulate the visualized model, and provide high quality views of the original physical object to the viewer.

### SUMMARY

According to the teachings of the present embodiment there is provided a method for generating three-dimensional models of physical objects, including the steps of providing a plurality of two dimensional images of a physical object, wherein the two-dimensional images are captured from a plurality of viewing angles of the physical object; associating each of the two-dimensional images with a viewing zone, wherein: the viewing zone includes a range of viewing angles of the physical object; and at least one of the viewing zones having a minimum of three shared boundaries; and processing the associated two-dimensional images for each of the viewing zones to generate a three-dimensional local model of the physical object for each of the viewing zones.

In an optional embodiment, the plurality of two-dimensional images are provided from a digital picture camera. In another optional embodiment, the plurality of two-dimensional images are provided from a digital video camera. In another optional embodiment, the plurality of two-dimensional images are provided from a storage system. In another optional embodiment, conventional techniques are used to process the two-dimensional images and generate the local model. In another optional embodiment, a first local model is derived from a first set of two-dimensional images and a second set of two-dimensional images, a second local model is derived from at least one two-dimensional image that is captured after the first set of two-dimensional images and before the second set of two-dimensional images. In another optional embodiment, one or more two-dimensional images are generated from the local models. In another optional embodiment, information is generated about the success or quality of the local model generation. In another optional embodiment, the local models are provided with a license.

In an optional embodiment, providing the plurality of two-dimensional images for processing includes providing a plurality of two-dimensional images; providing a three-dimensional model generation module; transferring the plurality of two-dimensional images to the three-dimensional model generation module; and processing the two-dimensional images by the three-dimensional model generation module to generate the local models.

In an optional embodiment, a notification is generated that the processing has been completed. In another optional embodiment, the local models are saved to a storage system. In another optional embodiment, the local models are sent to a given destination. In another optional embodiment, one or more two-dimensional images are generated from the local models. In another optional embodiment, information is generated about the success or quality of the local model generation.

According to the teachings of the present embodiment there is provided a method for viewing a visualized model including: providing a visualized model corresponding to a physical object, the visualized model including a plurality of local models of the physical object, wherein each of the local models corresponds to a given viewing zone, and at least one of the viewing zones having a minimum of three shared boundaries; providing a viewing angle of the visualized model; and rendering a view from the visualized model wherein the view is rendered as a function of the viewing angle in combination with one or more of the local models corresponding to the viewing angle.

In another optional embodiment, as the viewing angle changes to a new viewing angle, a weighted average technique is used to determine which one or more of the local models corresponds to the viewing angle. In another optional embodiment, as the viewing angle changes to a new viewing angle, a transparency technique is used to determine which one or more of the local models corresponds to the viewing angle. In another optional embodiment, as the viewing angle changes to a new viewing angle, any other known technique is used to determine which one or more of the local models corresponds to the viewing angle. In another optional embodiment, as the viewing angle changes to a new viewing angle, the rendering uses a weighted average of two or more of the local models to render the view. In another optional embodiment, as the viewing angle changes to a new viewing angle, the rendering uses a technique of transparency with the local models to render the view. In another optional embodiment, as the viewing angle changes to a new viewing angle, the rendering uses any other known technique to render the view.

According to the teachings of the present embodiment there is provided a system for generating three-dimensional models of physical objects, including: one or more image capture devices configured for providing a plurality of two dimensional images of a physical object, wherein the two-dimensional images are captured from a plurality of viewing angles of the physical object; a processing system containing at least one processor configured for associating each of the two-dimensional images with a viewing zone, wherein: the viewing zone includes a given range of viewing angles of the physical object; and at least one of the viewing zones having a minimum of three shared boundaries; and the processor is further configured for processing the associated two-dimensional images for each of the viewing zones to generate a three-dimensional local model of the physical object for each of the viewing zones.

In an optional embodiment, the image capture devices are digital picture cameras. In another optional embodiment, the image capture devices are digital video cameras. In another optional embodiment, a storage system provides the plurality of two-dimensional images. In another optional embodiment, the processor is further configured to use conventional techniques to process the two-dimensional images and generate the local model. In another optional embodiment, the processor is further configured to derive a first local model from a first set of two-dimensional images and a second set of two-dimensional images, and derive a second local model from at least one two-dimensional image that is captured after the first set of two-dimensional images and before the second set of two-dimensional images. In another optional embodiment, the processor is further configured to generate one or more two-dimensional images from the local models. In another optional embodiment, the processor is further configured to generate information about the success or quality of the local model generation. In another optional embodiment, the processor is further configured to provide the local models with a license. In another optional embodiment, the system is further configured to provide the plurality of two-dimensional images for processing by: providing a plurality of two-dimensional images; providing a three-dimensional model generation module; transferring the plurality of two-dimensional images to the three-dimensional model generation module; and processing the two-dimensional images by the three-dimensional model generation module to generate the local models.

In an optional embodiment, the system is further configured to generate a notification that the processing has been completed. In another optional embodiment, the system is further configured to save the local models to a storage system. In another optional embodiment, the system is further configured to send the local models to a given destination. In another optional embodiment, the system is further configured to generate one or more two-dimensional images from the local models. In another optional embodiment, the system is further configured to generate information about the success or quality of the local model generation.

According to the teachings of the present embodiment there is provided a system for viewing a visualized model including a processing system containing at least one processor configured for: providing a visualized model corresponding to a physical object, the visualized model including a plurality of local models of the physical object, wherein each of the local models corresponds to a given viewing zone, and at least one of the viewing zones having a minimum of three shared boundaries; providing a viewing angle of the visualized model; and rendering a view from the visualized model wherein the view is rendered as a function of the viewing angle in combination with one or more of the local models corresponding to the viewing angle.

In an optional embodiment, the processor is further configured that as the viewing angle changes to a new viewing angle, a weighted average technique is used to determine which one or more of the local models corresponds to the viewing angle. In another optional embodiment, the processor is further configured that as the viewing angle changes to a new viewing angle, a transparency technique is used to determine which one or more of the local models corresponds to the viewing angle. In another optional embodiment, the processor is further configured that as the viewing angle changes to a new viewing angle, any other known technique is used to determine which one or more of the local models corresponds to the viewing angle. In another optional embodiment, the processor is further configured that as the viewing angle changes to a new viewing angle, the rendering uses a weighted average of two or more local models to render the view. In another optional embodiment, the processor is further configured that as the viewing angle changes to a new viewing angle, the rendering uses a technique of transparency with the one or more local models to render the view. In another optional embodiment, the processor is further configured that as the viewing angle changes to a new viewing angle, the rendering uses any other known technique to render the view.

### BRIEF DESCRIPTION OF FIGURES

The embodiment is herein described, by way of example only, with reference to the accompanying drawings, wherein:

FIG. 1 is a method for generating a three-dimensional model of a physical object.

FIG. 2 is a method for viewing a visualized model.

FIG. 3 is a system for generating a three-dimensional model of physical objects and viewing a visualized model.

FIG. 4, a diagram of three-dimensional model generation.

FIG. 5A is an illustration of viewing zones for an object. FIG. 5B is a diagram of viewing zones and their boundaries for FIG. 5A.

FIG. 5C is a diagram of viewing zones and their boundaries in a general case of a visualized model.

### DETAILED DESCRIPTION

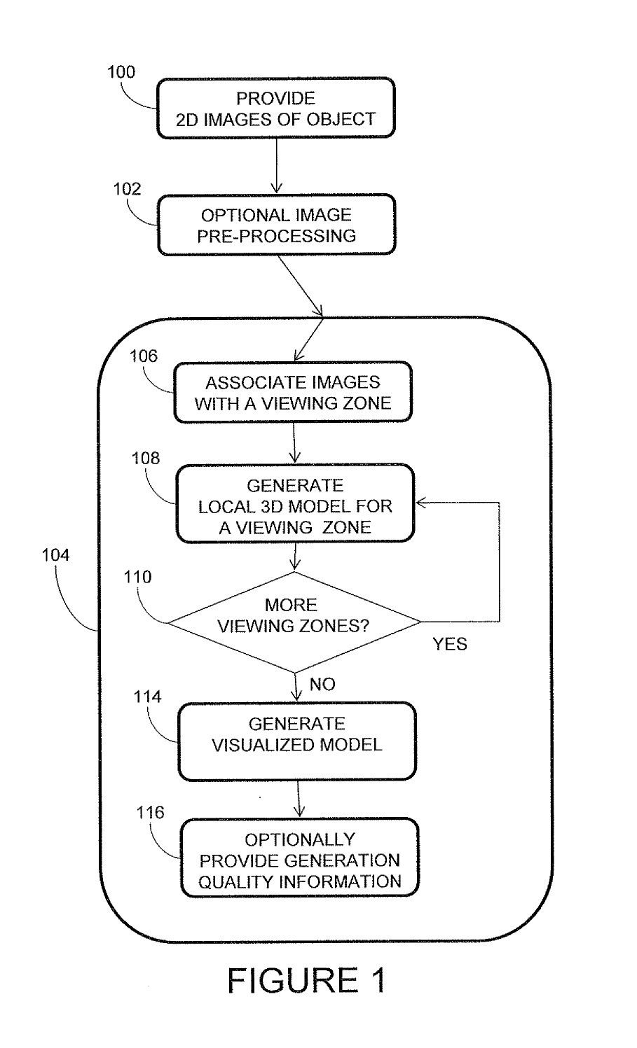

### FIGS. 1, 2, 3, 4, 5A, 5B, 5C

The principles and operation of this method according to the present embodiment may be better understood with reference to the drawings and the accompanying description. Conventional techniques restrict the decomposition of the problem of presenting a three-dimensional object given a set of two-dimensional images, into a two-part algorithm. As described above, this decomposition leads to using a three-dimensional reconstruction as the first stage, which optimizes the accuracy of the geometry reconstruction, regardless the accuracy of the model presentation. The results of the two-stage approach are limited by the quality of the model generated by the first stage. Because conventional techniques are focused on first generating a single, global, three-dimensional model, the criteria used to evaluate the technique is the quality of the generated model, as described in the background section of this document.

The restrictions of conventional techniques can be overcome by use of an innovative method for construction that uses information about how the model will be displayed to generate an innovative three-dimensional model. Whereas conventional techniques focus on generating a global high-quality model, one implementation of the method of this invention includes generating a plurality of local solutions. An innovative metric is used to evaluate the quality of the local solutions model. An innovative viewing method allows high-quality user views to be generated from the plurality of local solutions.

The current invention describes a method and system for generating a three-dimensional model of a physical object and providing high-quality views for user viewing. In these embodiments, a plurality of two-dimensional images can be provided from a variety of sources. An example of providing a plurality of images is a person using a digital camera to capture multiple images of a physical object, where the images include a plurality of viewing angles of the object.

The provided two-dimensional images are analyzed and organized so that images taken from similar viewing angles are associated with a viewing zone. Each group of associated images is used to generate (produce) a three-dimensional model of a portion of the physical object in the image, referred to as a local model. A local model is valid for a range of viewing angles, in contrast to a general model that is valid for any viewing angle. A collection of local models is referred to as a visualized model. As a user views the visualized model, the viewing module (for example, viewing software) uses the local model corresponding to the viewing zone of the user to present a high-quality view of the object from the viewing angle of the user. As the user turns the model (changes the user-viewing angle) the viewing software selects the most appropriate local model to use to render the image. The viewing module can also use more than one local model to render the image. This method facilitates the user always viewing a high-quality three-dimensional view.

The use of local models provides an advantage over the use of a conventional global model because the individual local models facilitate rendering a higher-quality view than a single global model. Conventional techniques combine all model information into a single three-dimensional model by minimizing a cost function that is defined by a particular algorithm. This conventional model contains depth errors due to the compensation process. In comparison, in this method all model information is not combined into a single three-dimensional model, facilitating improved quality in the provided views from the local models. Because the images associated with a viewing zone are relatively close, they provide a high level of redundancy and good correlation for generating a local model. This assumes that the viewing angle for the rendered view is within a viewing zone that has associated images.

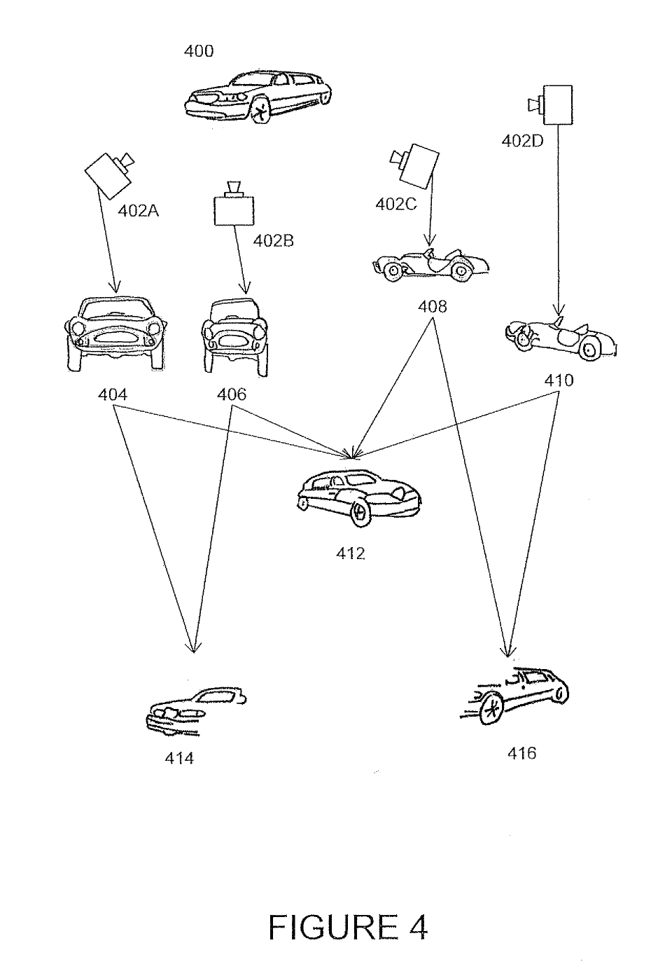

An example can be seen in FIG. 4, a diagram of three-dimensional model generation. Images of a physical object 400 are captured by one or more image capture devices from a plurality of viewing angles 402A, 402B, 402C, 402D. In conventional modeling, the captured two-dimensional images 404, 406, 408, 410, are all used to generate a single global three-dimensional model 412. In contrast, one implementation of the innovative method of this invention generates a plurality of local models. Images 404 and 406 can be used to generate local model 414. Similarly, images 408 and 410 can be used to generate local model 416. Because the images associated with a viewing zone are relatively close, inaccuracies in the local model do not significantly affect the quality of the rendered view. The local models can be used to provide views from angles not included in the original captured images.

One embodiment of a method to facilitate generating a three-dimensional model from a plurality of two-dimensional images starts with a plurality of two-dimensional images being transmitted to the generating module. The generating module uses the method of the above-described embodiment to generate a visualized model of the object. The visualized model is provided to a user for viewing.

Referring now to the drawings, FIG. 1 is a method for generating a three-dimensional model of a physical object. The method begins by providing a plurality of two-dimensional images of a physical object, shown in block 100. The images include views of the object from a plurality of viewing angles. The images may optionally be pre-processed, shown in block 102. Pre-processing includes any processing necessary to convert the provided images into the appropriate input for subsequent processing. An example of pre-processing is to change the data format of the provided images to a data format that can be read by the next step in the method or decompressing compressed formats. In the case where the input is a video sequence, pre-processing can include selection of frames. Preprocessing can also include segmenting the images to isolate the object of interest from the background. After any optional pre-processing, is performed the images are transferred to the generating module, shown in block 104.

The method of generating begins by associating each of the two-dimensional images with a viewing zone, shown in block 106. The provided two-dimensional images are analyzed and organized so that images captured from similar viewing angles are associated with a viewing zone. In this context, a viewing zone includes a given range of viewing angles of the physical object. A viewing angle is the place, position, or direction from which an object is presented to view. In simple terms, a viewing angle may include viewing an object from the front, back, or side. In a more specific example, the viewing angle can be specified using the azimuth and elevation of the view toward a designated reference point on the object. The range of the viewing zone will vary depending on the physical object being viewed, the quantity of pictures, the structure of the object, the viewing angles of the two-dimensional images, and other factors. For example, if there are many two-dimensional images of an object from many viewing angles that are relatively close, then the viewing zones of the object from that direction can be relatively narrow. If there are relatively few viewing angles of the object from a second direction, then the viewing zones of the object from that second direction will be relatively large. Another option is defining the viewing zone based on pre-defined criteria, such as an angle of orientation. Note that the order in which the images are provided to generate the local three-dimensional model is not limiting.

The method evaluates all of the provided images and associates every provided image with a corresponding calculated viewing zone. A non-limiting example is a case where a user takes pictures of a car as the user walks around the car. The user can initially take general pictures of all sides of the car, then subsequently takes more pictures of the front of the car, such as close-up pictures of details of the car hood, then goes to the back of the car and takes close-ups of the car trunk, and so forth. If these pictures are provided to the method in the order in which the pictures were captured, the method analyzes all of the pictures to create a plurality of viewing zones. For the viewing zones of the front of the car, some of the initially taken general pictures and some of the subsequently taken close-ups could be associated with the same viewing zone. This non-limiting example describes how a first local model is derived from a first set of two-dimensional images and a second set of two-dimensional images, and how a second local model is derived from at least one two-dimensional image that is captured after the first set of two-dimensional images and before the second set of two-dimensional images.

To associate an image with a viewing zone, first the camera information, including the position and orientation of the camera, is determined from an input image. Algorithms to determine camera information from an image are known in the art as ego motion algorithms. The output of an ego motion algorithm includes the camera information associated with the input image. The camera information is used to associate the image with a viewing zone. In one implementation, a distance threshold is defined, for example 5 degrees. The distance in degrees from the camera information to an orientation angle is calculated for each image. Each image that is within the range of the distance threshold is associated with the orientation angle and each orientation angle determines a viewing zone. This technique is known to work well when the distance of the camera from the object is greater than the size of the object. In a more efficient implementation, only groups of images that are beyond a given minimum distance from each other are used.

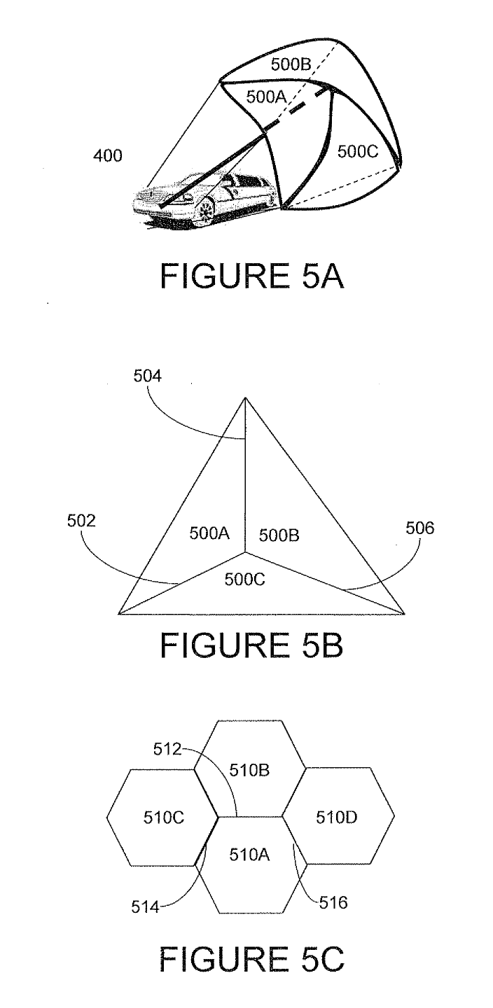

Referring to FIG. 5A is an illustration of viewing zones for an object. For object 400 viewing zone 500A is mostly the front, viewing zone 500B is mostly the top, and viewing zone 500C is mostly the right side of the object.

Referring to FIG. 5B is a diagram of viewing zones and their boundaries for FIG. 5A. In this case viewing zones 500A and 500C share boundary 502. Similarly viewing zones 500A and 500B share boundary 504, and viewing zones 50013 and 500C share boundary 506. Note that this is a degenerate case of the general visualized model where each pair of the three viewing zones shares a boundary. This allows the viewing angle to transition from any viewing zone to any other viewing zone in an arbitrary order.

Referring to FIG. 5C is a diagram of viewing zones and their boundaries in a general case of a visualized model. For the general case of a visualized model, at least one of the viewing zones must have a minimum of three shared boundaries. In this case viewing zone 510A shares three boundaries: with viewing zone 5108 boundary 512, with viewing zone 510C boundary 514, and with viewing 510B boundary 516. In the description of the viewing method, below, it is described how it is possible for the viewing angle to change from any viewing zone to any other viewing zone.

In block 108, the two-dimensional images associated with a viewing zone are processed to generate a three-dimensional model of a portion of the physical object. This three-dimensional model is referred to as a local model. Note that the local model is a complete set of model data, in other words, the model is not lacking data within itself, rather the description of local refers to the fact that the model is not of the complete physical object, but only models a portion of the physical object. Each local model also includes information on the viewing zone, or corresponding angle, for which the local model was created. The processing of the two-dimensional images uses conventional techniques to generate the local model. A variety of techniques for generating three-dimensional models from two-dimensional images is known in the art including multi-baseline stereo methods, and multi view stereo methods. Structure from motion (SFM) is another technique that can be used to find the three-dimensional structure of an object of interest by analyzing multiple views of the object. Depending on the application, conventional techniques, with their accompanying limitations, can be used to provide a three-dimensional model for a portion of an object for which there are no provided images, or that images do not contain sufficient information. An example of using a conventional technique is providing images of only one side of a basically symmetrical object, and symmetry is used to generate the other side, or hidden portion, of the object.

Generating a local model using images from within a viewing zone facilitates the generation of a three-dimensional model for that portion of the object. One implementation of an innovative metric to evaluate the quality of a model is defined as the difference between the original view and a rendered view generated from the model at the same given angle as the original view. This original two-dimensional image from a given angle may not have been provided to the algorithm but should be used as a ground truth image for evaluating the quality of the rendered view. The difference can be calculated using conventional image processing techniques such as L1 (sum of absolute differences—SAD), L2 (sum of squared differences—SSD), using a psychophysical image quality measurement technique, or another technique that is know in the art. This assumes that the two-dimensional image of the object was captured from the same viewing angle as the rendered view of the object. This metric for the quality of the model differs from the conventional metric of comparing a ground-truth three-dimensional model of the object to the global (single generated three-dimensional) model of the object.

The method continues generating additional local models, for each of the viewing zones, shown in block 110. When all of the viewing zones have been processed, the individual local models are combined to generate what is referred to as the visualized model for the object, shown in block 114. The visualized model can include each of the local models, as well as information on which parts of the object do not have a local model.

In an optional implementation, a series of two-dimensional pictures can be generated from the visualized model and provided to a user.

In an optional implementation, the method can include generating information about the success or quality of the visualized model generation. This information can include which viewing zones were included in the model, which viewing zones were not included in the model, and a metric of the quality of the visualized model.

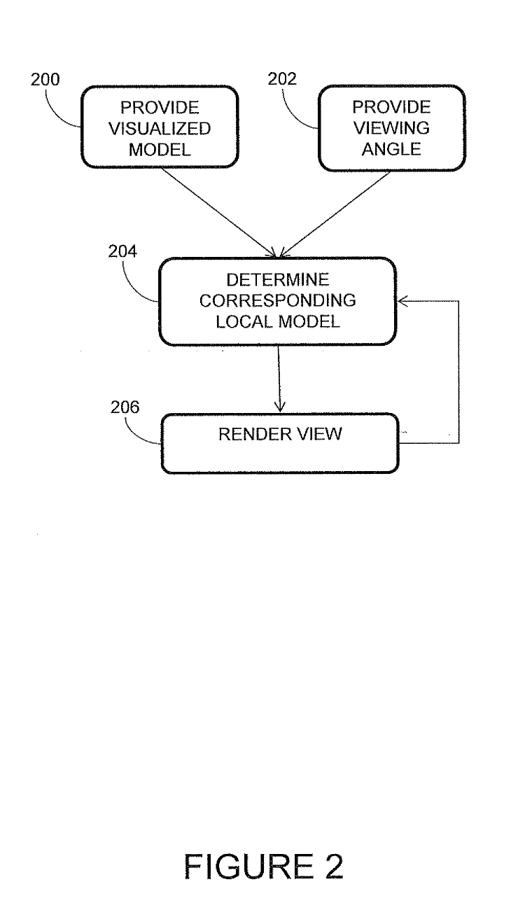

Referring now to the drawings, FIG. 2 is a method for viewing a visualized model. As a user views the visualized model, a viewing module uses the local model corresponding to the viewing zone of the user to render a high-quality view of the object from the viewing angle of the user. In this context, rendering refers to converting data from a file into visual form, as on a video display. As the user navigates the model (changes the user-viewing angle) the viewing module selects the most appropriate one or more of any of the local models to use to display the view. Examples of navigation include moving to the right, left, up, or down, moving closer to the object, moving away from the object, zooming-in, and zooming-out. The user can initially view the object from any arbitrary angle. From the current viewing angle, the object can be navigated in any arbitrary direction. The user can also circumnavigate the model and return to their original viewing angle and original view generated from the corresponding one or more local models. This method facilitates the user viewing a view derived from a three-dimensional model. If a local model is not available for the viewing angle of the user, conventional techniques can be used to display a view for the user.

The method for viewing a visualized model begins by providing a visualized model corresponding to a physical object, shown in block 200. This visualized model includes one or more local models of the physical object. A viewing angle of the visualized model is also provided, shown in block 202. In this context, the viewing angle also includes the distance from the user viewing point to the object. The visualized model and viewing angle can be provided from a variety of sources. Sources include the model generation method, databases, and communications, such as email, file transfer, and web services. Other options will be obvious to one knowledgeable in the art. The order of providing the visualized model and the viewing angle is non-limiting, either one can be provided first, or even a list of viewing angles can be provided to render multiple views of the physical object.

The viewing angle is used in combination with the visualized model to determine which one or more local models in the visualized model corresponds to the viewing angle, shown in block 204. A variety of techniques can be used to determine the best local model(s) to use to generate the new view. One implementation selects the local model that has been generated from the closest viewing angle. Other implementations are possible.

Rendering a view of the visualized model is shown in block 206. The rendering step uses one or more corresponding determined local models in combination with the viewing angle to produce a view of the physical object from the perspective of the provided viewing angle. As the current viewing angle changes, the method will eventually have to again determine which one or more local models to provide the view, shown in block 204. When the viewing angle changes from the current viewing angle to a new viewing angle it is possible to change the viewing zone from the current viewing zone to any other viewing zone in the visualized model. Each viewing zone has one or more boundaries with one or more other viewing zones. Boundaries between viewing zones are areas of transition from one viewing zone to another. When the viewing angle changes from a current viewing zone to a new viewing zone, the view rendered for the user can cross the boundary between viewing zones. Approaching and crossing a boundary between viewing zones corresponds to changing the primary local model being used to render the view. When crossing a boundary and switching models, it is desirable to provide a smooth transition in the views rendered for the user.

Switching between models can be accomplished through a variety of techniques. In one implementation, switching between models is based on the viewing angles from which the original two-dimensional images were taken. When the angle of the view is close to an original viewing angle, a view is rendered from the local model associated with that viewing angle. While the angle of the view of the model is within a given viewing zone, the local model for the given viewing zone is used to render the view. When the angle of the view changes to be in another viewing zone, the local model for that other viewing zone is used to render the view.

Other techniques can be used to determine which one or more local models to use to render the view. One optional technique is to use a weighted average of the viewing angle with each local model. The results of the weighted averages are compared to determine which local model to use as the primary local model to render the view.

Another optional technique for determining which one or more local models to use to render the view is an innovative use of a technique from computer graphics, generally known as transparency. In computer graphics, transparency refers to a specific part of an image or application window that takes on the color of whatever is beneath the image.

Given a viewing angle in a viewing zone, the method determines which first local model corresponds to the viewing angle. As the viewing angle changes, transparent areas of the first local model can correspond to visible areas of other local models. When the visible area, or areas, of another local model are a given amount, the method can use the other local model as the primary local model to render the view.

As the viewing angle changes and the method switches between viewing zones and switches between local models, it is desirable to have a smooth display of the views provided to the user. Optionally, techniques can be used to facilitate a smooth transition between local models when the viewing zone changes. One optional technique is to use a weighted average of a first local model, and a second local model. As the view changes to be a given distance away from an edge between a first viewing zone and a second viewing zone, a weighted average of the local model associated with the first viewing zone can be used in combination with the local model associated with the second viewing zone to render the view. Initially the rendered view will be heavily weighted toward using data from the first local model. As the viewing angle approaches the edge between viewing zones, the weight of the second local model will increase. As the viewing angle changes to be in the second viewing zone, the weight of the first local model will decrease. When the viewing angle is a given distance from the edge between the viewing zones, the rendering can be done using only the local model for that viewing zone. This use of a weighted average of more than one local model facilitates the rendering of views that appear to have a smooth transition, and the viewer is ideally not aware of the viewing zones from which the view is rendered.

Another optional technique that can be used to facilitate a smooth transition between local models when the viewing zone changes is a use of transparency. One technique for implementing transparency is known as alpha blending. The real world is composed of transparent, translucent, and opaque objects. Alpha blending is a technique for adding transparency information for translucent objects. It is implemented by rendering polygons through a stipple mask whose on-off density is proportional to the transparency of the object. The resultant color of a pixel is a combination of the foreground and background color. Given a viewing angle, a primary local model can be used to generate the view. This primary local model may have areas that are transparent or translucent. As the viewing angle changes, visible areas of other local models can be viewed through the transparent or translucent areas of the primary model. The rendering module can use the primary local model in combination with transparency through the primary local model and the corresponding visible areas of other local models to render a high-quality view. As the viewing angle changes, this technique can facilitate a smooth transition between rendered views.

In another implementation as the viewing angle transitions from the current viewing zone to a new viewing zone, the transparency of the local models corresponding to these zones changes. Using transparency as a function of viewing angle is an innovative technique facilitating providing a higher quality view to the user. Each local model contains information on the viewing zone, or corresponding original angle, for which the local model was created. In a case where the viewing angle is within a given range of the original angle for a local model, that local model can be used with no transparency to render a view. All of the other local models in the visualized model are completely transparent. As the viewing angle changes to be farther away from the original viewing angle of the current local model, the viewing angle is getting closer to an original viewing angle for a new viewing zone and its corresponding new local model. As the amount of transparency used with the current local model increases the amount of transparency used with the new local model decreases. The two local models and their corresponding transparencies are combined to produce a high quality view. Note that this technique is not limited to using only two models. All adjacent local models can be used with their appropriate transparency to render the view. In an optional implementation, a local model can contain information on the transparency that is to be used when using the local model from a given angle.

In a case where the viewing angle changes from a current viewing zone to a new viewing zone that is not adjacent to the current viewing zone, the views provided to the user depends on the application of this method. In one implementation, the view can switch, or change directly from the current view to a view from the new viewing angle. In another implementation, the intermediate viewing zones between the current viewing zone and the new viewing zone are calculated. A series of views are then generated and provided to the user showing the view as the angle changes from the current angle, toward the boundary with the first intermediate viewing zone, transitioning across the first boundary into the first intermediate viewing zone, and so on until reaching the new viewing angle. Other options for providing views from a current to a new viewing angle will be obvious to one skilled in the art.

In an optional implementation, if none of the local models corresponds to the viewing angle, the view can be generated using conventional three-dimensional modeling and viewing techniques. Appropriate techniques will depend on the application, and techniques such as using symmetry to construct portions of a three-dimensional model that do not have source images, or limiting the view of the user, are known in the art.

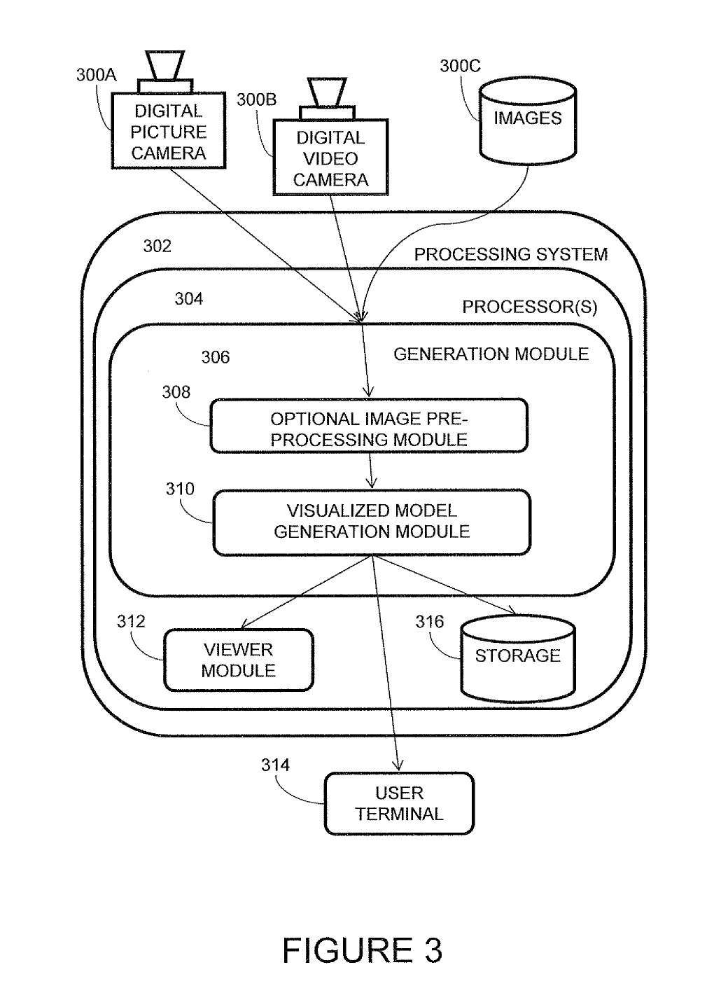

Referring now to the drawings, FIG. 3 is a system for generating a three-dimensional model of physical objects and viewing a visualized model. The plurality of two-dimensional images can be provided from a variety of sources. One example is a person, also referred to as the content owner, taking still pictures with a digital camera 300A. Another example is a person using a digital video camera to film an object from several different views 300B. The images can also be provided by an automated source on behalf of the content owner 300C. Other sources of images will be obvious to one skilled in the art.

The images are then transferred to a processing system 302 configured with at least one processor 304 configured with a generating module 306. The transfer can be done by a variety of conventional means or custom application, as determined by the specific implementation of the system. One example is the content owner transferring digital images from a camera to a home computer. From the content owner's computer, the digital image files can be transferred via a network to a computer running the generating module. In another implementation, the digital camera can be connected directly to a computer running the generating module. Other options will be obvious to one skilled in the art.

The two-dimensional images may optionally require pre-processing in optional image pre-processing module 30S. Pre-processing includes functions such as converting the format of the digital image file to a format that can be input to the generating module. One example of pre-processing is converting an MPEG video file into a sequence of JPEG files. Another example of pre-processing is to convert the file format of the video or images prior to transferring the image to the generating module. In the case where the input is a video sequence, pre-processing can include decimating the input to lower the number of frames needing processing. Decimation will reduce the computing power needed when the information provided by neighboring frames is not required. Decimation or selection of frames from a video sequence provides a series of still images for further processing. The implementation location and functions of any optional pre-processing will vary depending on the specific implementation of the system.

The plurality of images is processed by the visualized model generation module 310, using the method described elsewhere in this description, and generates a visualized model of the original physical object. The structure of the visualized model can vary depending on the application for which it is being used. In one implementation, the local models are stored in a given format in a single data file. In another implementation, the local models are stored are stored in individual files and optionally additional information is generated and stored, either together or separately from the local model files, to allow access and selection of the local model files.

Access to the visualized model by the user can be implemented in a variety of ways. In one implementation, the visualized module is sent to a viewer module 312 for creating and displaying views of the visualized model. In another implementation, the visualized model is transferred to a user terminal 314, content owner, or to another user. In another implementation, the visualized model is stored in a storage system 316, such as an online file system, or database, and the content owner is sent information on how to access the stored visualized model. Other implementation for user access to the visualized model will be obvious to one skilled in the art.

In an optional implementation, the generation module 306 can generate a series of two-dimensional images from the visualized model. These images can be generated based on user preference or a given set of criteria for the specific application. This series of images can be provided to the user. One example of generating a series of images is providing the user a series of eight images encompassing a 360-degree view of a given object.

In an optional implementation, the generation module 306 can generate information about the success, quality, failure, or other details of the generation of the three-dimensional model of the object. This information can be provided to the content owner or another user. An example of generating information is providing the content owner with the viewing zones that were not associated with any of the images. In other words, letting the content owner know which views of the object were not captured in the original images. This generating information can be used by the content owner to facilitate generating an improved visualized model. In our current example, the content owner can capture additional pictures of the object from additional viewing angles and send them to the model generation module for additional generating and improvement of the visualized model.

In an optional implementation, the visualized model can be provided with a license. This license can be dependent on time or other factors. For example, the visualized model can be provided free, but expires, or is no longer viewable after a given number of days. In another example, the visualized model can be provided with an unlimited license, allowing a user to view, use, and distribute the model, as they want. Note that licenses can also be associated with images and other products of this method. A variety of licensing techniques are known in the art.

The visualized model can be viewed by a user using a viewer tell terminal application. The viewer terminal application may be located on the user terminal or remotely accessed, providing display of the visualized model on the user terminal or another terminal. The viewer terminal application can include functionality, such as allowing the user to navigate the object in a variety of directions. Examples of navigation include moving to the right, left, up, or down, moving closer to the object, moving away from the object, zooming-in, and zooming-out. Note that the processing modules, viewer terminal application, and other system components can be implemented in a variety of locations and combinations, depending on the specific implementation of the system, and will be obvious to one skilled in the art.

It will be appreciated that the above descriptions are intended only to serve as examples, and that many other embodiments are possible within the scope of the present invention as defined in the appended claims.

What is claimed is:

1. A method for generating three-dimensional models of physical objects, comprising the steps of
(a) providing a plurality of two dimensional images of a physical object, wherein said two-dimensional images are captured from a plurality of viewing angles of said physical object;
(b) associating each of said two-dimensional images with a viewing zone, wherein:
(i) said viewing zone includes a range of viewing angles of said physical object; and
(ii) at least one of said viewing zones having a minimum of three shared boundaries; and
(c) processing the associated two-dimensional images for each of said viewing zones to generate a three-dimensional local model of said physical object for each of said viewing zones.

2. The method of claim 1 wherein said plurality of two-dimensional images are provided from a digital picture camera.

3. The method of claim 1 wherein said plurality of two-dimensional images are provided from a digital video camera.

4. The method of claim 1 wherein said plurality of two-dimensional images are provided from a storage system.

5. The method of claim 1 wherein conventional techniques are used to process said two-dimensional images and generate said local model.

6. The method of claim 1 wherein a first local model is derived from a first set of two-dimensional images and a second set of two-dimensional images, and wherein a second local model is derived from at least one two-dimensional image that is captured after said first set of two-dimensional images and before said second set of two-dimensional images.

7. The method of claim 1 further comprising generating one or more two-dimensional images from the local models.

8. The method of claim 1 further comprising generating information about the success or quality of the local model generation.

9. The method of claim 1 wherein the local models are provided with a license.

10. The method of claim 1 wherein said providing said plurality of two-dimensional images for processing comprises:
(a) providing a plurality of two-dimensional images;
(b) providing a three-dimensional model generation module;
(c) transferring said plurality of two-dimensional images to said three-dimensional model generation module; and
(d) processing said two-dimensional images by said three-dimensional model generation module to generate the local models.

11. The method of claim 10 further comprising generating a notification that said processing has been completed.

12. The method of claim 10 further comprising saving the local models to a storage system.

13. The method of claim 10 further comprising sending the local models to a given destination.

14. The method of claim 10 further comprising generating one or more two-dimensional images from the local models.

15. The method of claim 10 further comprising generating information about the success or quality of the local model generation.

16. A method for viewing a visualized model comprising:
(a) providing a visualized model corresponding to a physical object, said visualized model including a plurality of local models of said physical object, wherein each of said local models corresponds to a given viewing zone, and at least one of said viewing zones having a minimum of three shared boundaries;
(b) providing a viewing angle of said visualized model; and
(c) rendering a view from said visualized model wherein said view is rendered as a function of said viewing angle in combination with one or more of said local models corresponding to said viewing angle.

17. The method of claim 16 wherein as said viewing angle changes to a new viewing angle, a weighted average technique is used to determine which one or more of said local models corresponds to said viewing angle.

18. The method of claim 16 wherein as said viewing angle changes to a new viewing angle, a transparency technique is used to determine which one or more of said local models corresponds to said viewing angle.

19. The method of claim 16 wherein as said viewing angle changes to a new viewing angle, any other known technique is used to determine which one or more of said local models corresponds to said viewing angle.

20. The method of claim 16 wherein as said viewing angle changes to a new viewing angle, said rendering uses a weighted average of two or more of said local models to render said view.

21. The method of claim 16 wherein as said viewing angle changes to a new viewing angle, said rendering uses a technique of transparency with the said local models to render said view.

22. The method of claim 16 wherein as said viewing angle changes to a new viewing angle, said rendering uses any other known technique to render said view.

23. A system for generating three-dimensional models of physical objects, comprising:
(a) one or more image capture devices configured for providing a plurality of two dimensional images of a physical object, wherein said two-dimensional images are captured from a plurality of viewing angles of said physical object;
(b) a processing system containing at least one processor configured for associating each of said two-dimensional images with a viewing zone, wherein:
(i) said viewing zone includes a given range of viewing angles of said physical object; and
(ii) at least one of said viewing zones having a minimum of three shared boundaries; and
(c) said processor is further configured for processing the associated two-dimensional images for each of said viewing zones to generate a three-dimensional local model of said physical object for each of said viewing zones.

24. The system of claim 23 wherein said image capture devices are digital picture cameras.

25. The system of claim 23 wherein said image capture devices are digital video cameras.

26. The system of claim 23 wherein a storage system provides said plurality of two-dimensional images.

27. The system of claim 23 wherein said processor is further configured to use conventional techniques to process said two-dimensional images and generate said local model.

28. The system of claim 23 wherein said processor is further configured to derive a first local model from a first set of two-dimensional images and a second set of two-dimensional images, and derive a second local model from at least one two-dimensional image that is captured after said first set of two-dimensional images and before said second set of two-dimensional images.

29. The system of claim 23 wherein said processor is further configured to generate one or more two-dimensional images from the local models.

30. The system of claim 23 wherein said processor is further configured to generate information about the success or quality of the local model generation.

31. The system of claim 23 wherein said processor is further configured to provide the local models with a license.

32. The system of claim 23 further configured to provide said plurality of two-dimensional images for processing by:
(a) providing a plurality of two-dimensional images;
(b) providing a three-dimensional model generation module;
(c) transferring said plurality of two-dimensional images to said three-dimensional model generation module; and
(d) processing said two-dimensional images by said three-dimensional model generation module to generate the local models.

33. The system of claim 32 further configured to generate a notification that said processing has been completed.

34. The system of claim 32 further configured to save the local models to a storage system.

35. The system of claim 32 further configured to send the local models to a given destination.

36. The system of claim 32 further configured to generate one or more two-dimensional images from the local models.

37. The system of claim 32 further configured to generate information about the success or quality of the local model generation.

38. A system for viewing a visualized model comprising a processing system containing at least one processor configured for:
(a) providing a visualized model corresponding to a physical object, said visualized model including a plurality of local models of said physical object, wherein each of said local models corresponds to a given viewing zone, and at least one of said viewing zones having a minimum of three shared boundaries;
(b) providing a viewing angle of said visualized model; and
(c) rendering a view from said visualized model wherein said view is rendered as a function of said viewing angle in combination with one or more of said local models corresponding to said viewing angle.

39. The system of claim 38 wherein said processor is further configured that as said viewing angle changes to a new viewing angle, a weighted average technique is used to determine which one or more of said local models corresponds to said viewing angle.

40. The system of claim 38 wherein said processor is further configured that as said viewing angle changes to a new viewing angle, a transparency technique is used to determine which one or more of said local models corresponds to said viewing angle.

41. The system of claim 38 wherein said processor is further configured that as said viewing angle changes to a new viewing angle, any other known technique is used to determine which one or more of said local models corresponds to said viewing angle.

42. The system of claim 38 wherein said processor is further configured that as said viewing angle changes to a new viewing angle, said rendering uses a weighted average of two or more local models to render said view.

43. The system of claim 38 wherein said processor is further configured that as said viewing angle changes to a new viewing angle, said rendering uses a technique of transparency with the said one or more local models to render said view.

44. The system of claim 38 wherein said processor is further configured that as said viewing angle changes to a new viewing angle, said rendering uses any other known technique to render said view.
